(19) United States
(12) Patent Application Publication
(10) Pub. No.: US 2026/0158855 A1
(43) Pub. Date: Jun. 11, 2026

(54) VEHICLE CONTROL DEVICE AND VEHICLE CONTROL METHOD USING THE SAME

(71) Applicants: Hyundai Motor Company, Seoul (KR); Kia Corporation, Seoul (KR)

(72) Inventors: Ju Ho Choi, Hwaseong-Si (KR); June Kyu Park, Hwaseong-Si (KR); Hae Dong Youn, Hwaseong-Si (KR); Sang Ki Seo, Hwaseong-Si (KR); Da Won Jeong, Hwaseong-Si (KR); Jae Hong Choi, Hwaseong-Si (KR); Dong Ho Kwon, Hwaseong-Si (KR)

(21) Appl. No.: 19/252,308

(22) Filed: Jun. 27, 2025

(30) Foreign Application Priority Data
Dec. 9, 2024 (KR) 10-2024-0181918

(51) Int. Cl. B60H 1/00; B60L 58/13

(52) U.S. Cl. CPC B60H 1/00735; B60H 1/00392; B60H 1/00849; B60L 58/13; B60L 2240/34; B60L 2240/662

(57) ABSTRACT

The present disclosure relates to a control device of a vehicle and a method using the same. The control deice includes an air conditioner, and a controller circuit configured to operate, based on a predetermined discharge condition being satisfied, the air conditioner such that a state of charge (SoC) of a battery of the vehicle reaches a target SoC.

### CROSS-REFERENCE TO RELATED APPLICATION

This application claims priority to Korean Patent Application No. 10-2024-0181918, filed in the Korean Intellectual Property Office on Dec. 9, 2024, the entire contents of which are incorporated herein by reference.

### TECHNICAL FIELD

The present disclosure relates to a vehicle control device and a vehicle control method using the same, and more specifically, to a control device for an electric vehicle including an air conditioning system and a vehicle control method using the same.

### BACKGROUND

Gasoline engines and diesel engines using fossil fuels have many drawbacks, including environmental pollution due to exhaust gas, global warming due to carbon dioxide, respiratory diseases caused by ozone generation, and the like. In addition, the supply of fossil fuels on the planet is limited and will eventually be at risk of being exhausted.

To address the aforementioned issues, various types of electric vehicles have been developed, including all-electric vehicles (EVs) powered by a drive motor, hybrid electric vehicles (HEVs) powered by a combination of both engine and drive motor, and fuel cell electric vehicles (FCEVs) powered by a drive motor with power generated by fuel cells.

The electric vehicles may be equipped with a drive motor to drive the vehicle, as well as a battery to supply power to the drive motor. For all-electric vehicles or plug-in hybrid vehicles, the battery may be charged using an external charging device before driving.

The matters described in this Background section are only for enhancement of understanding of the background of the disclosure, and should not be taken as acknowledgement that they correspond to prior art already known to those skilled in the art.

### SUMMARY

The present disclosure has been made to solve the above-mentioned problems occurring in the prior art while advantages achieved by the prior art are maintained intact.

An aspect of the present disclosure provides a vehicle control device capable of controlling the state of charge (SoC) of a battery according to a specified situation or specified condition, and a vehicle control method using the same.

An aspect of the present disclosure provides a vehicle control device capable of preventing a fire accident that may occur in an electric vehicle by implementing a forced discharge mode, and a vehicle control method using the same.

An aspect of the present disclosure provides a vehicle control device capable of preventing overcharging in high-voltage charging, and a vehicle control method using the same.

An aspect of the present disclosure provides a vehicle control device capable of controlling an air conditioning system in a discharge mode, and a vehicle control method using the same.

An aspect of the present disclosure provides a vehicle control device capable of controlling the state of charge of a battery through control of an air conditioning system without changing a hardware unit, and a vehicle control method using the same.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a control device of a vehicle may include: an air conditioner; and a controller circuit configured to operate, based on a predetermined discharge condition being satisfied, the air conditioner such that a state of charge (SoC) of a battery of the vehicle reaches a target SoC.

The controller circuit may be configured to operate the air conditioner by performing one of: setting, based on an external temperature being greater than a reference temperature, a first target internal temperature for the air conditioner; or setting, based on the external temperature being less than the reference temperature, a second target internal temperature for the air conditioner. The first target internal temperature may be less than the reference temperature. The second target internal temperature may be greater than the reference temperature.

The air conditioner may include a heater, a cooler, and a fan. The controller circuit may be configured to operate the air conditioner by performing one of: operate the cooler based on a target internal temperature for the air conditioner being set to be less than a reference temperature; or operate the heater based on the target internal temperature being set to be greater than the reference temperature.

The controller circuit may be configured to operate the air conditioner by operating at least one of the cooler or the heater at maximum blower capacity.

The controller circuit may be configured to control the air conditioner by controlling the fan to operate in an outside air mode, in which outside air is drawn into the vehicle.

The controller circuit may be configured to operate the air conditioner by operating at least one of the cooler or the heater in a wind mode at a maximum power consumption level of the air conditioner.

The air conditioner may include a heater and a cooler. The controller circuit may be configured to operate the air conditioner by: setting a target temperature for a rear cabin area of the vehicle; and controlling at least one of the cooler or the heater such that an air temperature of the rear cabin area reaches the target temperature.

The predetermined discharge condition may include: receiving a signal indicating selection of a discharge mode. The target SoC may be between 60% and 80%.

The predetermined discharge condition may include detecting that the SoC of the battery exceeds a full SoC during vehicle charging or within a specified period of time after the vehicle charging.

The controller circuit may be further configured to, based on the SoC of the battery reaching the target SoC, power off the vehicle.

According to one or more example embodiments of the present disclosure, a method performed by an apparatus of a vehicle may include: monitoring whether a predetermined discharge condition for the vehicle is satisfied; and operating, based on the predetermined discharge condition being satisfied, an air conditioner of the vehicle such that a state of charge (SoC) of a battery of the vehicle reaches a target SoC.

Operating the air conditioner may include performing one of: setting, based on an external temperature being greater than a reference temperature, a first target internal temperature for the air conditioner; or setting, based on the external temperature being less than the reference temperature, a second target internal temperature for the air conditioner. The first target internal temperature may be less than the reference temperature. The second target internal temperature may be greater than the reference temperature.

Operating the air conditioner may include performing one of: controlling the air conditioner to cool the vehicle based on a target internal temperature for the air conditioner being set to be less than a reference temperature; or controlling the air conditioner to heat the vehicle based on the target internal temperature being set to be greater than the reference temperature.

Operating the air conditioner may include cooling or heating the vehicle at maximum blower capacity.

Operating the air conditioner may include controlling the air conditioner to draw outside air into the vehicle.

Operating the air conditioner may include cooling or heating the vehicle in a wind mode at a maximum power consumption level of the air conditioner.

The method may further include: setting a target temperature for a rear cabin area of the vehicle; and controlling the air conditioner to cool or heat the vehicle such that an air temperature of the rear cabin area reaches the target temperature.

The predetermined discharge condition may include: receiving a signal indicating selection of a discharge mode. The target SoC may be between 60% and 80%.

The predetermined discharge condition may include detecting that the SoC of the battery exceeds a full SoC during vehicle charging or within a specified period of time after the vehicle charging.

According to one or more example embodiments of the present disclosure, a vehicle may include: an air conditioner; a battery; a sensor configured to detect at least one of a temperature associated with the battery or an external temperature; a processor; and a memory storing at least one instruction that, when executed by the processor communicating with the memory, is configured to cause the vehicle to: operate, based on a predetermined discharge condition being satisfied, the air conditioner such that a state of charge (SoC) of the battery reaches a target SoC. The predetermined discharge condition may include at least one of: receiving a signal indicating selection of a discharge mode, or detecting that the SoC of the battery exceeds a full SoC during vehicle charging or within a specified period of time after the vehicle charging.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of an example vehicle control device including an air conditioner;

FIG. 2 is a control flowchart for describing an example vehicle control method;

FIG. 3 is a control flowchart for describing an example vehicle control method;

FIG. 4 is a block diagram showing a configuration of an example vehicle control device;

FIG. 5 is a control flowchart for describing an example vehicle control method;

FIG. 6 is a block diagram illustrating a configuration of an example vehicle control device;

FIG. 7 is a control flowchart for describing an example vehicle control method; and

FIG. 8 illustrates an example computing system.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiment(s) of the present disclosure, a detailed description of well-known features or functions will be ruled out in order not to unnecessarily obscure the gist of the present disclosure.

In describing the components of the example embodiment(s) according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

For various types of electric vehicles equipped batteries, and especially for vehicles that are placed in an idle state for an extended period of time, such as vehicles being shipped overseas, a method of forcibly discharging batteries may be necessary in order to control and regulate the state of charge (SoC) of the batteries in an optimal condition and also to reduce the risk of battery-related fires.

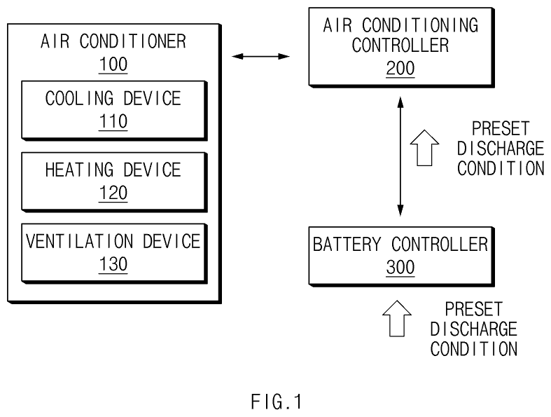

Hereinafter, one or more example embodiments of the present disclosure will be described in detail with reference to FIGS. 1 through 8.

FIG. 1 is a block diagram showing a configuration of a vehicle control device including an air conditioner.

Referring to FIG. 1, a vehicle control device may be implemented inside a vehicle. In this case, the vehicle control device may be integrally formed with internal control units of the vehicle, or may be implemented as a separate device and connected to the control units of the vehicle by separate connection means. In addition, the vehicle control device may be included in an electric vehicle that drives a drive motor by charging a battery.

As illustrated, the vehicle control device may include an air conditioner 100, an air conditioning controller (also referred to as a controller) 200, and a battery controller 300.

The air conditioner 100 may control the temperature, humidity, air cleanliness, and/or air flow inside the vehicle. The air conditioner 100 may include a blower motor, a compressor, an evaporator (e.g., an evaporator coil), a condensing coil, an expansion valve, a refrigerant, a heater core (e.g., a heating element), and/or a blend door actuator (also referred to as a temp door actuator). The air conditioner 100 may be implemented as a cooling device (also referred to as a cooler) 110, a heating device (also referred to as a heater) 120, and a ventilation device (also referred to as a ventilator or a fan) 130 that control air conditions inside the vehicle. The air conditioner 100 may be configured to include an air conditioning system and a thermal energy system that drive a high-voltage load, and may cool or heat the air inside the vehicle under the control of the air conditioning controller 200. For example, the air conditioner 100 may include a high-voltage PTC heater (6 KW) as the air conditioning system, an electric compressor (8 KW) as the thermal energy system, or the like.

The cooling device 110 may be implemented with an air conditioner, and the heating device 120 may be a heating device that uses electric energy, such as a positive temperature coefficient (PTC) heater. The PTC heater may be also used as an auxiliary heating device to supplement the heating performance in existing gasoline (or diesel) vehicles.

The ventilation device 130 may be a blower fan that discharges heated or cooled air into the vehicle interior. In addition, the ventilation device 130 may introduce or block outside air into the vehicle interior according to specific control.

The battery controller 300 may be implemented with a BMS (Battery Management System) that monitors and manages the state of a battery in the vehicle. The battery controller 300 may monitor the state of charge (SoC) of the battery, detect whether the SoC of the battery reaches a target SoC, and transmit the result to the air conditioning controller 200.

The air conditioning controller 200 may provide overall control of the air conditioner 100 in response to a user's operation or a specific signal, and may include a wireless communication module not shown.

According to a preset discharge condition, the air conditioning controller 200 may operate the air conditioner 100 to bring the SoC of the in-vehicle battery to the target SoC.

In other words, the air conditioner 100, such as a high-voltage component, may deplete the SoC of the battery in a situation where a battery discharge is required. Further, the air conditioning controller 200 may control the air conditioner 100 to maintain a discharge rate above a certain SoC value.

As will be described later, the situation where a battery discharge is required may include a situation in which there is a need to lower the SoC of the battery before shipping an electric vehicle for export, or a need to induce a battery discharge when the vehicle's battery is overcharged.

The preset discharge condition may involve receiving a user-selected signal to activate a discharge mode, to lower the SoC of the vehicle battery to a preset SoC, or detecting that the SoC of the battery exceeds a full SoC during vehicle charging or within a specified period of time after charging.

The air conditioning controller 200 may set a target internal temperature (e.g., target air temperature) by comparing the external temperature to a reference temperature. The reference temperature may refer to a temperature set for determining whether to cool or heat the air inside the vehicle, and the target internal temperature may refer to a temperature for the air inside the vehicle to reach based on the reference temperature, that is, a target temperature for continuing to operate the air conditioner 100.

According to an example, when the external temperature is higher than the reference temperature, the target internal temperature may be set lower than the reference temperature, and when the external temperature is lower than the reference temperature, the target internal temperature may be set higher than the reference temperature. In other words, when the external temperature is higher than the reference temperature, the target internal temperature may be set lower than the reference temperature because the higher external temperature indicates a need for cooling in the vehicle, and when the external temperature is lower than the reference temperature, the target internal temperature may be set higher than the reference temperature because the lower external temperature indicates a need for heating in the vehicle.

In summary, the air conditioning controller 200 may operate the cooling device 110 when the target internal temperature is set lower than the reference temperature, and may operate the heating device 120 when the target internal temperature is set higher than the reference temperature.

In an example, the target internal temperature may be adaptively set to take into account the season, humidity, discharge time, or the like. For example, in spring or autumn, the external temperature outside the vehicle and the internal temperature inside the vehicle may not be significantly different, in which case the heating and cooling load may be easily lowered, and the target internal temperature may be set to account for the seasonal conditions. In other words, because the goal of cooling and heating is to discharge the battery, the target internal temperature may be set to increase a heating and cooling load.

For example, when the reference temperature is set to 25° C., a first target internal temperature for cooling control may be set to 17° C. and a second target internal temperature for heating control may be set to 27° C. The greater the difference between the reference temperature and the target internal temperature, the higher the heating and cooling load. Therefore, it is desirable to set the target internal temperature by taking into account a target battery SoC and a discharge time.

Further, the air conditioning controller 200 may control a wind direction such that the heating and cooling load inside the vehicle is not easily lowered and is maintained continuously, for example, may set the wind direction to a vent and floor mode.

Furthermore, the air conditioning controller 200 may control the ventilation device to operate in an outside air mode (also referred to as a fresh air mode, e.g., 100% outside air intake) in which outside air is drawn into the vehicle. As outside air is drawn into the vehicle, it may serve to increase the heating and cooling load inside the vehicle.

The vent and floor mode is the most power consuming mode as it allows the air temperature to drop rapidly. The air conditioning controller 200 may set the heating and cooling load to be large by continuously supplying outside air to maximize power consumption, which may continuously induce the discharge of the battery.

Further, the air conditioning controller 200 may operate the cooling device 110 or the heating device 120 at maximum blower capacity to maximize heat exchange performance.

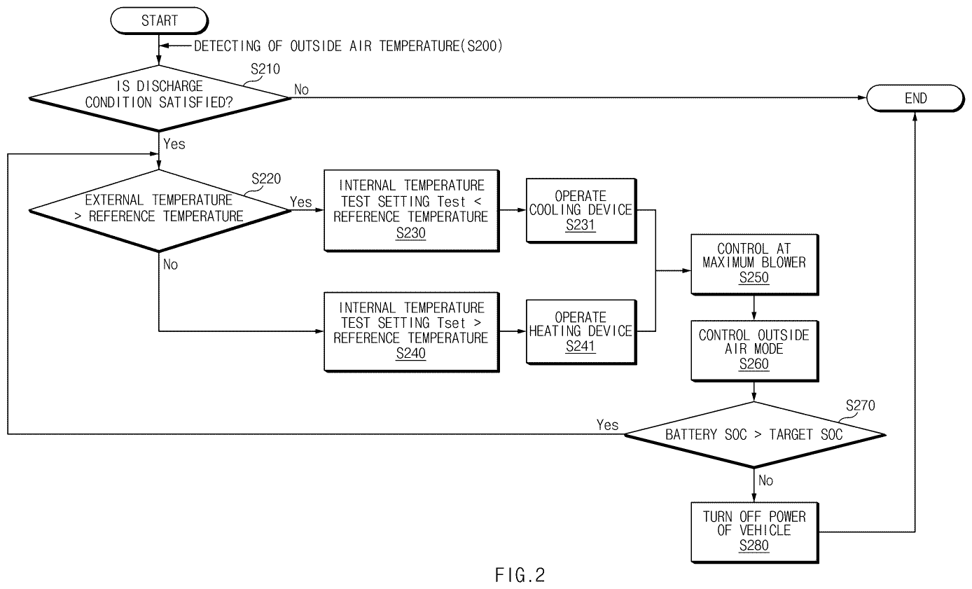

FIG. 2 is a control flowchart for describing a method of controlling a vehicle, such as an example vehicle shown in FIG. 1.

First, as shown, an outside air temperature may be continuously detected (S200).

Further, the air conditioning controller 200 may set a reference temperature for a forced discharge mode in advance.

The vehicle control device may determine, monitor, or detect whether a preset discharge condition is satisfied (S210).

As described above, the preset discharge condition may involve receiving a user-selected signal to activate a discharge mode, to lower the SoC of the vehicle battery to a preset SoC, or detecting that the SoC of the battery exceeds a full SoC during vehicle charging or within a specified period of time after charging.

When the discharge condition is satisfied, the air conditioning controller 200 may compare an external temperature of the vehicle to a reference temperature (S220).

The reference temperature may be set to, for example, 25° C., and it may be determined whether the external temperature, i.e., outside air temperature exceeds 25° C.

When the external temperature is higher than the reference temperature of 25° C., a target internal temperature Tₛₑₜ may be set lower than the reference temperature, for example, to 17° C. (S230).

Because the external temperature exceeds 25° C. if the target internal temperature is set to 17° C., the air conditioning controller 200 may operate the cooling device 110 to lower the internal temperature of the vehicle (S231).

In this case, the cooling device 110 may be controlled to a wind mode, such as the vent and floor mode, in which maximum power is consumed by rapidly lowering the temperature of the air.

Furthermore, the cooling device 110 may be set to an auto mode in which the vehicle is automatically started to enter a forced discharge mode, rather than a manual mode activated by a user's operation.

On the other hand, when the external temperature is lower than the reference temperature of 25° C., the target internal temperature Tₛₑₜ may be set higher than the reference temperature, for example, to 27° C. (S240).

When the target internal temperature is set to 27° C. and the external temperature is less than or equal to 25° C., the air conditioning controller 200 may operate the heating device 120 to raise the internal temperature of the vehicle (S241).

In this case, the heating device 120 may be controlled in a wind mode, such as the vent and floor mode, in which maximum power is consumed by rapidly raising the temperature of the air.

In an example, the air conditioning controller 200 may control the heating device 120 to operate in a dehumidification mode (e.g., MAX DEF mode) in which cold air is discharged for heating. Depending on the vehicle, the air conditioner or heater may be controlled in accordance with the MAX DEF mode, in which case the MAX DEF mode is useful to operate the heating device 120.

As described above, when the cooling or heating control is initiated, the air conditioning controller 200 may operate the cooling device 110 or the heating device 120 at the maximum blower (S250) and control the ventilation device 130 to operate an outside air mode in which outside air is drawn into the vehicle (S260).

In other words, the air conditioning controller 200 may set the heating and cooling load to be large by continuously supplying outside air to maximize power consumption, which may continuously induce the discharge of the battery.

The battery controller 300 may continuously monitor whether the battery SoC satisfies a target SoC (e.g., whether the battery SoC exceeds 40-45%) (S270) and transmit detection results to the air conditioning controller 200.

If the battery SoC reaches the target SoC (e.g., when the battery SoC is less than or equal to 40-45%), the air conditioning controller 200 may stop the operation of the cooling device 110 or the heating device 120.

When the forced discharge mode is terminated, the vehicle may be controlled to be powered off (S280).

Because the battery SoC has reached the target SoC, the vehicle may be powered off to prevent a further discharge.

On the other hand, when the battery SoC has not reached the target SoC, the control process for cooling or heating may be repeated continuously.

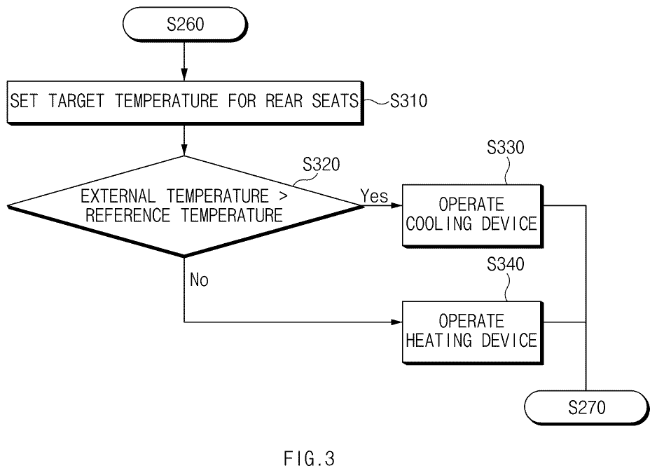

FIG. 3 is a control flowchart for describing a vehicle control method.

FIG. 3 may be performed separately or in conjunction with the control method of FIG. 2, and may be applied to a rear seat of a vehicle in which air conditions may be regulated independently of the driver and passenger seats of the vehicle.

In an example, as shown in FIG. 3, when the control of the air conditioner 100 is completed, a target temperature (e.g., target air temperature) for a rear seat may be set (S310). The target temperature for rear seats (e.g., for a rear cabin area) may be set by considering a target internal temperature, the size of the vehicle, an external temperature, and the like, and may be set automatically when a forced discharge mode is activated, or be set through a user interface (UI).

For example, when a first target internal is 17° C. and a second target internal temperature is 27° C., the target temperature for the rear seat may be set to approximately 20 to 25° C., more specifically, approximately 22 or 23° C. Alternatively, according to an example, the target temperature for rear seats may be set to a middle value between the first target internal temperature and the second target internal temperature.

When the target temperature for rear seats is set, the air conditioning controller 200 may control the air conditioner 100 for cooling control or heating control such that the temperature of rear seats reaches the target temperature for rear seats.

When the external temperature is detected to be higher than a reference temperature (S320), the cooling device 110 is operated (S330), and when the external temperature is detected to be lower than the reference temperature (S320), the heating device 120 may be operated (S340).

According to an example, when there are two or more rows of rear seats, each row may be operated individually, and all rear seats may be controlled to the same target temperature.

Alternatively, according to an example, the rear seats may also have a plurality of target internal temperatures set according to the external temperature and the reference temperature, as in FIG. 2.

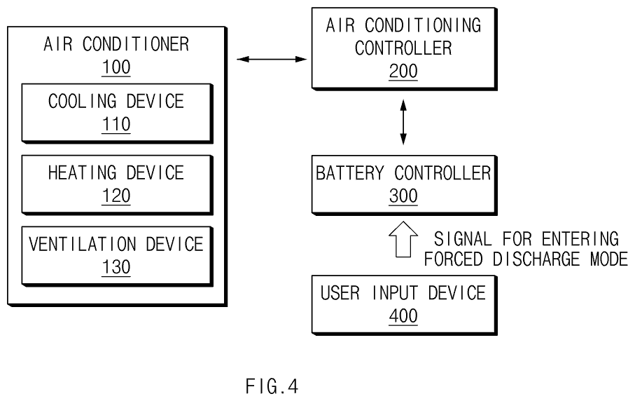

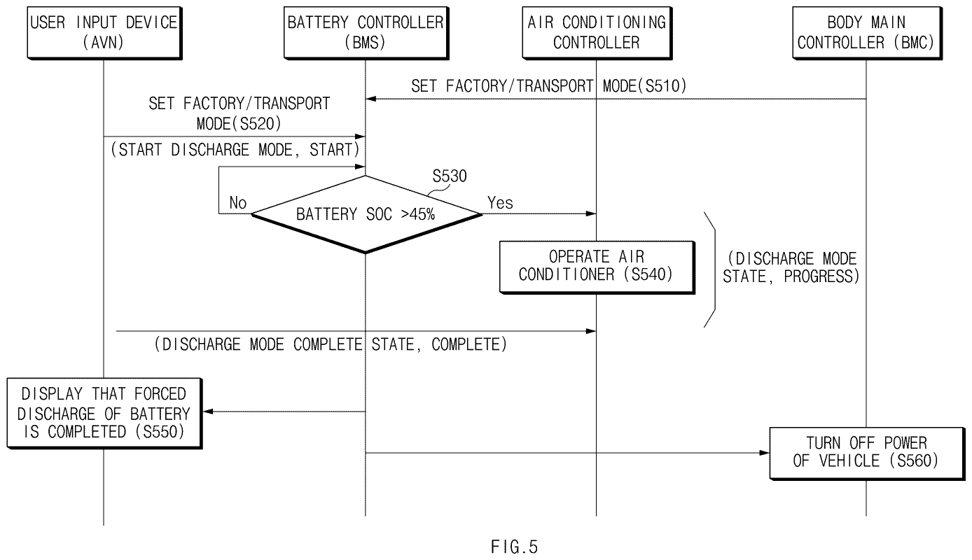

FIG. 4 is a block diagram showing a configuration of an example vehicle control device. FIG. 5 is a control flowchart for describing an example vehicle control method (e.g., an example vehicle control as shown in FIG. 4). For example, the vehicle control device of FIG. 4 may perform the process of FIG. 5.

As illustrated, the vehicle control device may further include a user input device 400.

The user input device 400 may be implemented as an Audie Video Navigation (AVN) in the vehicle. The AVN may include a user interface (UI) such as a user operation button, a touch pad capable of receiving a user input, or a touch sensor. The AVN may serve as a UI for activating a forced discharge mode, and when the forced discharge mode is completed, display the completion.

The user may select to enter the forced discharge mode through the user input device 400, and a signal for entering the forced discharge mode according to the user's selection may be transmitted to the battery controller 300 and the air conditioning controller 200.

The forced discharge mode may be a mode in which the SoC of the vehicle battery is reduced to 60% to 80% of the SoC of a finished vehicle. For example, assuming that the SoC of the finished vehicle is 60%, when the forced discharge mode is selected, the SoC of the vehicle battery may be lowered to a range of 40% to 50%.

While a finished electric vehicle is being transported to a user, for example, when the finished electric vehicle is shipped on a ship for export or transported through another vehicle, a fire may occur due to battery ignition, etc. In other words, there is a risk of battery ignition or fire accidents during the electric vehicle's transportation, and to resolve this, it is necessary to control the SoC of the battery of the finished vehicle below a certain range.

In this specific case, the forced discharge mode may be entered through the user's selection and the SoC of the battery may be controlled. For example, when a battery with a SoC of 60% is supplied from a battery pack manufacturer and a finished vehicle is produced using the battery, the SoC of the battery may need to be reduced to 45% or less, or 40%, to ensure safety for export. The SoC of the battery may be adjusted at the finished vehicle manufacturing plant, and may be discharged before shipment.

FIG. 5 is a control flow chart for an example vehicle control method of a vehicle in forced discharge mode. For example, if an operator turns on a vehicle's engine (e.g., EV READY) while the vehicle is parked in a storage lot before shipment, and put the vehicle in the forced discharge mode, the vehicle's battery SoC may be controlled to reach a target value, and the engine may be automatically turned off when (e.g., the moment or after) the battery SoC reaches the target value.

As illustrated, the user input device 400 may be implemented as an AVN in the vehicle, and the battery controller 300 may be implemented as a BMS (Battery Management System), and a body main controller (BMC) may participate in the control process to control the power of the vehicle. The BMS may control the sequence of the forced discharge mode in the vehicle, monitor the battery SoC, and determine whether the forced discharge mode is completed. The BMC may control the vehicle power shutdown after the end of forced discharge mode.

First, the vehicle may be set to factory/transport mode (S510) because the vehicle enters the forced discharge mode without being transported directly to the user.

In this case, a power data center (PDC) may send a signal for setting the mode of the vehicle to a factory/transport mode to the battery controller 300, the air conditioning controller 200, and the body main controller (BMC) such that the forced discharge mode is not activated after the vehicle is transported to an end user, i.e., a customer.

When the forced discharge mode is selected (S520) via the user input device 400, the discharge mode is started (Start).

The battery controller 300 may monitor the battery SoC to determine whether the battery SoC is less than or equal to a certain value, such as 40% or 45% (S530).

When the battery SoC is greater than 40% or 45%, the air conditioning controller 200 may operate the air conditioner 100 to maximize battery consumption in the vehicle (S540).

The air conditioner 100, i.e., the in-vehicle air conditioning system, may be controlled to cool or heat based on an outside air temperature and a target internal temperature, and may be controlled to automatically operate for a discharge rate above a certain SoC.

The target internal temperature may be set to allow maximum power to be used even in spring/autumn conditions, taking into account the factory and shipping environment. For example, the target internal temperature may be set to 17° C. or 27° C. depending on the external temperature conditions such that the heating and cooling loads is set to be large (setting 1), and the wind direction may be set to the vent and floor mode depending on the conditions such that the heating and cooling loads inside the vehicle is maintained continuously without being easily lowered (setting 2).

Furthermore, the ventilation device 130 may be controlled in an outside air mode to allow 100% fresh air to enter (setting 3), and a fan, that is, a blower may be operated at the maximum level to ensure maximum heat exchange performance (setting 4). When the airflow is able to set to 8 levels, the blower may be maximally set to an eighth level.

When the user enters the forced discharge mode via the AVN, the settings 1 to 4 described above may be controlled automatically, or some of the settings 1 to 4 may be selected according to the user's setting.

In other words, since the forced discharge mode may be activated based on a selection operation by the user through a UI such as a button (e.g., controlled by the hardware unit), the discharge function may be applied without changing the software of an existing air conditioning controller.

The battery SoC monitoring of the battery controller 300 and the automatic operation of the air conditioner 100 may be named as a discharge mode process.

When the battery SoC is 40% or 45% or lower, no further discharge is required, and the discharge mode is completed.

When the SoC has reached a target SoC, the user input device 400 may indicate that the forced discharge for the battery has been completed (S550) and the vehicle may be powered off by the body main controller (S560).

The vehicle may be controlled to be powered off to prevent further discharge from occurring in the vehicle.

Subsequently, the shipping process for the vehicle may proceed when the operator has confirmed the battery SoC.

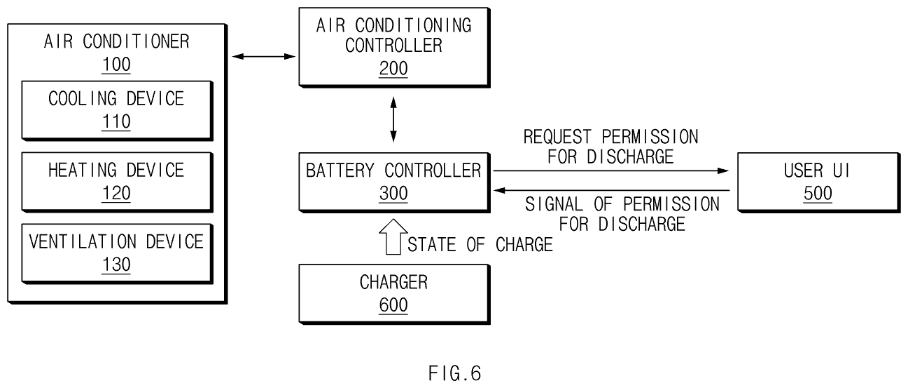

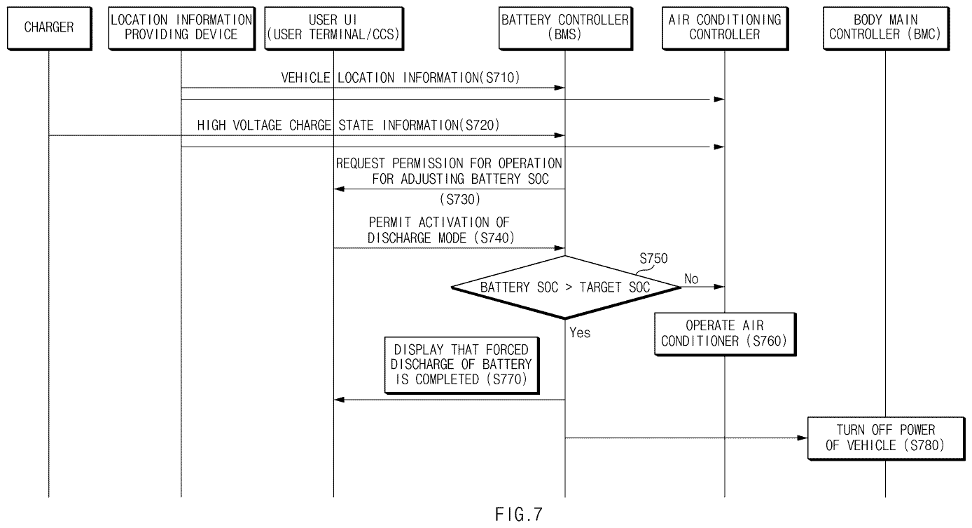

FIG. 6 is a block diagram illustrating a configuration of an example vehicle control device, and FIG. 7 is a control flow chart for describing an example vehicle control method (e.g., as shown in FIG. 6). The process shown in FIG. 7 may be performed by, for example, the example vehicle control device of FIG. 6.

As shown, a vehicle control device may further include a UI 500 and a charger 600 in the vehicle control device of FIG. 1.

The UI 500 may be implemented with a user handheld terminal and/or a Connected Car Service (CCS) or the like, and may receive user consent to adjust a SoC or notify the completion of operation of adjusting the SoC.

The charger 600 may be a charging device for high-voltage charging, and may include a charging connector for high-voltage charging. The high voltage may refer to a voltage of 400 volts to 800 volts.

The high-voltage SoC may be adjusted through operation of the air conditioning system when an overcharge of the battery is detected. In other words, during the high-voltage SoC of a vehicle battery, when an overcharge compared to the target SoC is detected or a battery discharge operation is required, a discharge may be performed. The high-voltage SoC may be adjusted by operating high-voltage components of the air-conditioning system which are functional when the vehicle is stationary.

For example, high-voltage charging is possible when the navigation location information indicates that the vehicle is within a certain distance, such as 50 meters, from a high-voltage charging station, and the vehicle's high-voltage charging connector is connected. When such a high voltage charging is available, the discharge mode may enter a ready state.

Specifically, the battery management system (BMS) may detect whether the overcharge or discharge requirements are satisfied while the vehicle is undergoing high-voltage charging, or up to one hour after the end of charging, and may notify the user via the UI 500, such as the CCS, that the discharge mode is to proceed and request permission for the discharge operation. When the user's signal to allow the discharge operation is not received for a certain period of time, the discharge mode may be activated. The vehicle control device may monitor the target SoC, and may terminate the discharge mode when the battery reaches the target SoC. The termination of the discharge mode may also be notified to the user, for example via the CCS.

Typically, when the vehicle is charged at high voltage, the maximum SoC is set to 90% or 80% rather than 100% for battery protection or charging time. When the user wants a maximum charge, the SoC may reach 90% or 80% set in advance. However, it may happen that the SoC exceeds the maximum SoC, which defeats the purpose of limiting the maximum SoC. To prevent malfunctions in the vehicle's battery or prolonged charging times, the battery SoC may be monitored to control the SoC.

FIG. 7 illustrates a control flowchart for describing a discharge mode different from that in FIG. 5. If the SoC of the vehicle exceeds the full SoC during charging or for a specific period of time after charging, the air conditioner 100 may be activated.

The vehicle location information may be transmitted from a location information provider, such as a navigation device, to the battery controller 300 and the air

### Conditioning Controller 200 (S710).

Because the discharge mode may be entered during the vehicle's charging process, whether the vehicle is able to be charged may be detected. If the vehicle is detected to have entered a certain range of a charging station where charging is possible, the state information may be transmitted to the battery controller 300 and the air conditioning controller 200.

When charging is initiated at the charging station or charging is completed, charging state information indicating high-voltage charging may be transmitted from the charger 600 to the battery controller 300 and the air conditioning controller 200 (S720).

User confirmation may be required for the discharge mode to be executed.

As illustrated, when the vehicle location information and the charging state information are received, the battery controller 300 may request the user's consent to permit the operation for adjusting the battery SoC (S730).

As described above, the request signal may be transmitted to the user terminal and/or the CCS, and the user may transmit a signal permitting activation of the discharge mode back to the battery controller 300 (S740).

When the user does not permit activation of the discharge mode within a certain period of time, the discharge mode may be set to be executed automatically for vehicle safety. Alternatively, the discharge mode may be set not to be executed without the user's consent signal.

When the user's consent signal is received, the battery controller 300 may request the air conditioning controller 200 to perform the air conditioning operation for adjusting the battery SoC and the air conditioning controller 200 may prepare the operation of the air conditioner 100 for battery discharge.

The battery controller 300 may continuously monitor the battery SoC to determine whether the battery SoC is less than or equal to a target SoC (S750).

When the battery SoC exceeds the target SoC, the air conditioning controller 200 may save the last mode of the air conditioner 100 and operate the air conditioner 100 to induce battery discharge in the vehicle (S760).

The air conditioner 100, i.e., the in-vehicle air conditioning system, may be controlled to cool or heat based on an outside air temperature and a target internal temperature, and may be controlled to operate automatically for a discharge rate above a certain level.

The target internal temperature may be set to maximize power consumption, considering factory and shipping environments, even under spring or autumn conditions. For example, the target internal temperature may be set to 17° C. or 27° C. depending on the external temperature conditions such that the heating and cooling loads is set to be large (setting 1), and the wind direction may be set to the vent and floor mode depending on the conditions such that the heating and cooling loads inside the vehicle is maintained continuously without being easily lowered (setting 2).

Furthermore, the ventilation device 130 may be controlled in an outside air mode to allow 100% fresh air to enter (setting 3), and a fan, that is, a blower may be operated at the maximum level to ensure maximum heat exchange performance (setting 4). If the airflow can be set to 8 levels, the blower may be maximally set to an eighth level.

If it is determined to enter the discharge mode, the settings 1 to 4 described above may be controlled automatically, or some of the settings 1 to 4 may be selected according to the user's setting.

If the battery SoC is less than the target SoC, no further discharge is required, and the discharge mode is completed.

If the SoC has reached a target SoC, the UI 500 may indicate that the forced discharge for the battery has been completed (S770) and the vehicle may be powered off by the body main controller (S780).

In the case of discharge, it is not necessary that control signals for factory/transport/customer mode are transmitted or received by the power data center PDC, because the vehicle is still required to be operational after the vehicle is manufactured and transported to a customer which is an end user.

As described herein, the SoC of the battery may be controlled through the control of the air conditioning system without changing the hardware unit, thereby preventing a fire accident that may occur in an electric vehicle or preventing overcharging upon the high-voltage charge.

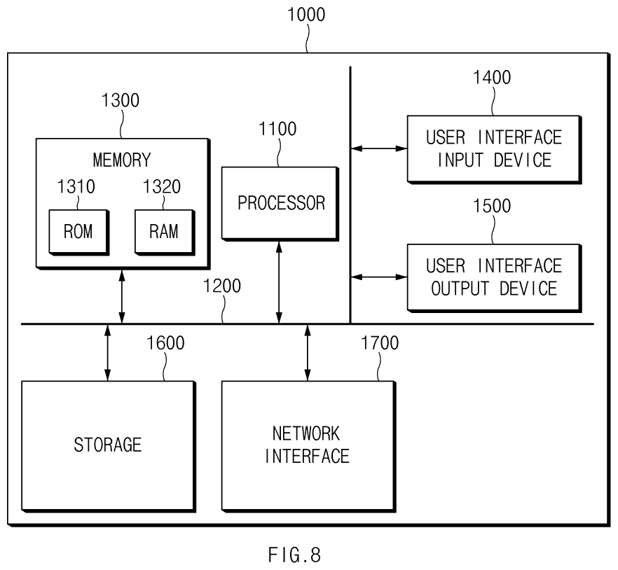

FIG. 8 illustrates a computing system.

Referring to FIG. 8, a computing system 1000 may include at least one processor 1100, a memory 1300, a user interface input device 1400, a user interface output device 1500, storage 1600, and a network interface 1700, which are connected with each other via a bus 1200. The processor of FIG. 8 may be implemented with the battery controller 300 and the air conditioning controller 200 of FIGS. 1, 4, and 5.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) and a random access memory (RAM).

Thus, the operations of the method or the algorithm described in connection with one or more embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an erasable programmable ROM (EPROM), an electrically erasable programmable ROM (EEPROM), a register, a hard disk, a removable disk, and a compact disc ROM (CD-ROM).

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control device includes an air conditioner and an air conditioning controller that operates the air conditioner such that a state of charge (SoC) of a battery in a vehicle reaches a target state of charge in response to a preset discharge condition.

The air conditioning controller may set an internal target temperature by comparing an external temperature to a reference temperature, set the internal target temperature lower than the reference temperature when the external temperature is higher than the reference temperature, and set the internal target temperature higher than the reference temperature when the external temperature is lower than the reference temperature.

The air conditioner may include a heating device, a cooling device, and a ventilation device, and the air conditioning controller may operate the cooling device when the internal target temperature is set lower than the reference temperature, and operate the heating device when the internal target temperature is set higher than the reference temperature.

The air conditioning controller may operate the cooling device or the heating device at maximum blower.

The air conditioning controller may control the ventilation device to operate in an outside air mode in which outside air is drawn into the vehicle.

The air conditioning controller may operate the cooling device or the heating device in a wind mode that consumes maximum power.

The air conditioning controller may set a target temperature for rear seats, and control the cooling device or the heating device such that the rear seats reach the target temperature for rear seats.

The discharge condition may include receiving a signal for selecting a discharge mode that discharges the state of charge of the battery to 60% to 80% of a state of charge of a battery in a finished vehicle.

The discharge condition may include detecting that the state of charge of the battery exceeds a full state of charge during vehicle charging or within a specified period of time after charging.

The vehicle is powered off when the state of charge reaches the target state of charge.

According to an aspect of the present disclosure, a vehicle control method includes monitoring whether a preset discharge condition is satisfied, and operating an air conditioner of a vehicle such that a state of charge (SoC) of a battery in a vehicle reaches a target state of charge in response to the discharge condition.

The vehicle control device described above with reference to the drawings may include at least one hardware for performing the above-described functions based on one or more instructions. Here, at least one hardware may include at least one processor.

The above description is merely illustrative of the technical idea of the present disclosure, and various modifications and variations may be made without departing from the essential characteristics of the present disclosure by those skilled in the art to which the present disclosure pertains.

Accordingly, the example embodiment(s) disclosed in the present disclosure are not intended to limit the technical idea of the present disclosure but to describe the present disclosure. The scope of the technical idea of the present disclosure is not limited by the example embodiment(s). The scope of protection of the present disclosure should be interpreted by the following claims, and all technical ideas within the scope equivalent thereto should be construed as being included in the scope of the present disclosure.

The present technology provides a vehicle control device capable of controlling the state of charge (SoC) of a battery according to a specified situation or specified condition, and a vehicle control method using the same.

The present technology provides a vehicle control device capable of preventing a fire accident that may occur in an electric vehicle by implementing a forced discharge mode, and a vehicle control method using the same.

The present technology provides a vehicle control device capable of preventing overcharging in high-voltage charging, and a vehicle control method using the same.

The present technology provides a vehicle control device capable of controlling an air conditioning system in a discharge mode, and a vehicle control method using the same.

The present technology provides a vehicle control device capable of controlling the state of charge of a battery through control of an air conditioning system without changing a hardware unit, and a vehicle control method using the same.

In addition, various effects may be provided that are directly or indirectly understood through the disclosure.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A control device of a vehicle, the control device comprising:
an air conditioner; and
a controller circuit configured to operate, based on a predetermined discharge condition being satisfied, the air conditioner such that a state of charge (SoC) of a battery of the vehicle reaches a target SoC.

2. The control device of claim 1, wherein the controller circuit is configured to operate the air conditioner by performing one of:
setting, based on an external temperature being greater than a reference temperature, a first target internal temperature for the air conditioner, wherein the first target internal temperature is less than the reference temperature; or
setting, based on the external temperature being less than the reference temperature, a second target internal temperature for the air conditioner, wherein the second target internal temperature is greater than the reference temperature.

3. The control device of claim 1, wherein the air conditioner comprises a heater, a cooler, and a fan, and
wherein the controller circuit is configured to operate the air conditioner by performing one of:
operate the cooler based on a target internal temperature for the air conditioner being set to be less than a reference temperature; or
operate the heater based on the target internal temperature being set to be greater than the reference temperature.

4. The control device of claim 3, wherein the controller circuit is configured to operate the air conditioner by operating at least one of the cooler or the heater at maximum blower capacity.

5. The control device of claim 3, wherein the controller circuit is configured to control the air conditioner by controlling the fan to operate in an outside air mode, in which outside air is drawn into the vehicle.

6. The control device of claim 3, wherein the controller circuit is configured to operate the air conditioner by operating at least one of the cooler or the heater in a wind mode at a maximum power consumption level of the air conditioner.

7. The control device of claim 1, wherein the air conditioner comprises a heater and a cooler, and
wherein the controller circuit is configured to operate the air conditioner by:
setting a target temperature for a rear cabin area of the vehicle; and
controlling at least one of the cooler or the heater such that an air temperature of the rear cabin area reaches the target temperature.

8. The control device of claim 1, wherein the predetermined discharge condition comprises: receiving a signal indicating selection of a discharge mode, and wherein the target SoC is between 60% and 80%.

9. The control device of claim 1, wherein the predetermined discharge condition comprises detecting that the SoC of the battery exceeds a full SoC during vehicle charging or within a specified period of time after the vehicle charging.

10. The control device of claim 1, wherein the controller circuit is further configured to, based on the SoC of the battery reaching the target SoC, power off the vehicle.

11. A method performed by an apparatus of a vehicle, the method comprising:
monitoring whether a predetermined discharge condition for the vehicle is satisfied; and
operating, based on the predetermined discharge condition being satisfied, an air conditioner of the vehicle such that a state of charge (SoC) of a battery of the vehicle reaches a target SoC.

12. The method of claim 11, wherein the operating of the air conditioner comprises performing one of:
setting, based on an external temperature being greater than a reference temperature, a first target internal temperature for the air conditioner, wherein the first target internal temperature is less than the reference temperature; or
setting, based on the external temperature being less than the reference temperature, a second target internal temperature for the air conditioner, wherein the second target internal temperature is greater than the reference temperature.

13. The method of claim 11, wherein the operating of the air conditioner comprises performing one of:
controlling the air conditioner to cool the vehicle based on a target internal temperature for the air conditioner being set to be less than a reference temperature; or
controlling the air conditioner to heat the vehicle based on the target internal temperature being set to be greater than the reference temperature.

14. The method of claim 13, wherein the operating of the air conditioner comprises cooling or heating the vehicle at maximum blower capacity.

15. The method of claim 13, wherein the operating of the air conditioner comprises controlling the air conditioner to draw outside air into the vehicle.

16. The method of claim 13, wherein the operating of the air conditioner comprises cooling or heating the vehicle in a wind mode at a maximum power consumption level of the air conditioner.

17. The method of claim 11, further comprising:
setting a target temperature for a rear cabin area of the vehicle; and
controlling the air conditioner to cool or heat the vehicle such that an air temperature of the rear cabin area reaches the target temperature.

18. The method of claim 11, wherein the predetermined discharge condition comprises: receiving a signal indicating selection of a discharge mode, and wherein the target SoC is between 60% and 80%.

19. The method of claim 11, wherein the predetermined discharge condition comprises detecting that the SoC of the battery exceeds a full SoC during vehicle charging or within a specified period of time after the vehicle charging.

20. A vehicle comprising:
an air conditioner;
a battery;
a sensor configured to detect at least one of a temperature associated with the battery or an external temperature;
a processor; and
a memory storing at least one instruction that, when executed by the processor communicating with the memory, is configured to cause the vehicle to:
operate, based on a predetermined discharge condition being satisfied, the air conditioner such that a state of charge (SoC) of the battery reaches a target SoC,
wherein the predetermined discharge condition comprises at least one of: receiving a signal indicating selection of a discharge mode, or detecting that the SoC of the battery exceeds a full SoC during vehicle charging or within a specified period of time after the vehicle charging.
